(19) United States
(12) Patent Application Publication
(10) Pub. No.: US 2023/0078269 A1
(43) Pub. Date: Mar. 16, 2023

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Takeshi TAKEMOTO, Nagoya-shi (JP); Toyokazu NAKASHIMA, Nagoya-shi (JP); Haruka HIROOKA, Nagoya-shi (JP); Hiroyuki NAKAJIMA, Katsushika-ku (JP); Takashi HORI, Iwakura-shi (JP)

(73) Assignee: TOYOTA JIDOSHA KABUSHIKI KAISHA, Toyota-shi (JP)

(21) Appl. No.: 17/931,978

(22) Filed: Sep. 14, 2022

(30) Foreign Application Priority Data
Sep. 16, 2021 (JP) 2021-151597

(51) Int. Cl. G06F 21/62; G06Q 50/26

(52) U.S. Cl. CPC G06F 21/6245; G06Q 50/26

(57) ABSTRACT

An information processing apparatus refers to a first database where vehicle identification data and consent status data are stored for each of a plurality of vehicles and ownership period data is stored for each vehicle in a first vehicle group, acquires, for each vehicle in a second vehicle group for which corresponding consent status data indicates that an owner consented to disclosure other than the vehicles in the first vehicle group, corresponding vehicle identification data as inquiry vehicle data, transmits request data including the inquiry vehicle data to a management system, receives response data including vehicle identification data for a vehicle among the vehicles in the second vehicle group for which a certain registration procedure has been performed within a reference period, and calculates, for the vehicle identified by the vehicle identification data included in the response data, a corresponding end-of-ownership date based on a reference period.

### CROSS-REFERENCE TO RELATED APPLICATION

This application claims priority to Japanese Patent Application No. 2021-151597 filed on Sep. 16, 2021, the entire contents of which are incorporated herein by reference.

### TECHNICAL FIELD

The present disclosure relates to an information processing apparatus and an information processing method.

### BACKGROUND

Patent Literature (PTL) 1 discloses an apparatus that manages consent for the use of personal data.

### CITATION LIST

### Patent Literature

PTL 1: JP 2015-141642 A

### SUMMARY

Service providers that provide services to disclose information obtained from vehicles, such as vehicle diagnostic logs, to third parties with the consent of individual owners may have difficulty in detecting an owner change, as illustrated in FIG. 15. As a result, the period during which an owner's consent to disclosure of information obtained from a vehicle is valid (hereinafter referred to as the “consent period”) is not properly managed, and the information obtained from the vehicle may be disclosed in an undesirable manner beyond the consent period.

It would be helpful to avoid undesirable disclosure of information obtained from a vehicle.

An information processing apparatus according to the present disclosure includes: a controller configured to refer to a first database in which vehicle identification data, consent status data, and ownership period data are stored, the vehicle identification data identifying each vehicle of a plurality of vehicles, the consent status data indicating whether, for each vehicle of the plurality of vehicles, an owner consented to disclosure of information obtained from a vehicle, and the ownership period data indicating a date on which an owner terminated ownership as an end-of-ownership date for each of vehicles in a first vehicle group among the plurality of vehicles, and acquire, for each of vehicles in a second vehicle group for which corresponding consent status data indicates that an owner consented to the disclosure other than the vehicles in the first vehicle group among the plurality of vehicles, corresponding vehicle identification data as inquiry vehicle data; and a communication interface configured to: transmit request data including the inquiry vehicle data acquired by the controller to a management system that manages a second database in which data indicating a date on which one or more types of registration procedures were performed and a type of registration procedure performed is stored for each vehicle of the plurality of vehicles; and receive response data that is transmitted in response to the request data transmitted and includes vehicle identification data for a vehicle among the vehicles in the second vehicle group for which a certain type of registration procedure has been performed within a reference period, wherein the controller is configured to calculate, for the vehicle identified by the vehicle identification data included in the response data received by the communication interface, a corresponding end-of-ownership date based on the reference period.

An information processing method according to the present disclosure includes: referring to a first database in which vehicle identification data, consent status data, and ownership period data are stored, the vehicle identification data identifying each vehicle of a plurality of vehicles, the consent status data indicating whether, for each vehicle of the plurality of vehicles, an owner consented to disclosure of information obtained from a vehicle, and the ownership period data indicating a date on which an owner terminated ownership as an end-of-ownership date for each of vehicles in a first vehicle group among the plurality of vehicles, and acquiring, for each of vehicles in a second vehicle group for which corresponding consent status data indicates that an owner consented to the disclosure other than the vehicles in the first vehicle group among the plurality of vehicles, corresponding vehicle identification data as inquiry vehicle data; transmitting request data including the inquiry vehicle data acquired to a management system that manages a second database in which data indicating a date on which one or more types of registration procedures were performed and a type of registration procedure performed is stored for each vehicle of the plurality of vehicles; receiving response data that is transmitted in response to the request data transmitted and includes vehicle identification data for a vehicle among the vehicles in the second vehicle group for which a certain type of registration procedure has been performed within a reference period; and calculating, for the vehicle identified by the vehicle identification data included in the response data received, a corresponding end-of-ownership date based on the reference period.

The present disclosure makes it easier to avoid undesirable disclosure of information obtained from a vehicle.

### BRIEF DESCRIPTION OF THE DRAWINGS

In the accompanying drawings:

FIG. 1 illustrates a configuration of a system according to a first embodiment;

FIG. 2 illustrates databases referred to by an information processing apparatus according to the first embodiment;

FIG. 3 is a table illustrating examples of data stored in a first database according to the first embodiment;

FIG. 4 is a table illustrating examples of data stored in a second database according to the first embodiment;

FIG. 5 is a flowchart illustrating a process in a first phase according to the first embodiment;

FIG. 6 is a flowchart illustrating a process in a second phase according to the first embodiment;

FIG. 7 is a flowchart illustrating a process in a third phase according to the first embodiment;

FIG. 8 is a flowchart illustrating a process in a fourth phase according to the first embodiment;

FIG. 9 illustrates a specific example of request data according to the first embodiment;

FIG. 10 illustrates a specific example of response data according to the first embodiment;

FIG. 11 illustrates databases referred to by an information processing apparatus according to a second embodiment;

FIG. 12 is a flowchart illustrating a process in a first phase according to the second embodiment;

FIG. 13 illustrates a specific example of request data according to the second embodiment;

FIG. 14 illustrates a specific example of updating contract status data according to the second embodiment; and

FIG. 15 is a conceptual diagram illustrating a relationship between the ownership periods of the former and new owners when the ownership of a vehicle is changed.

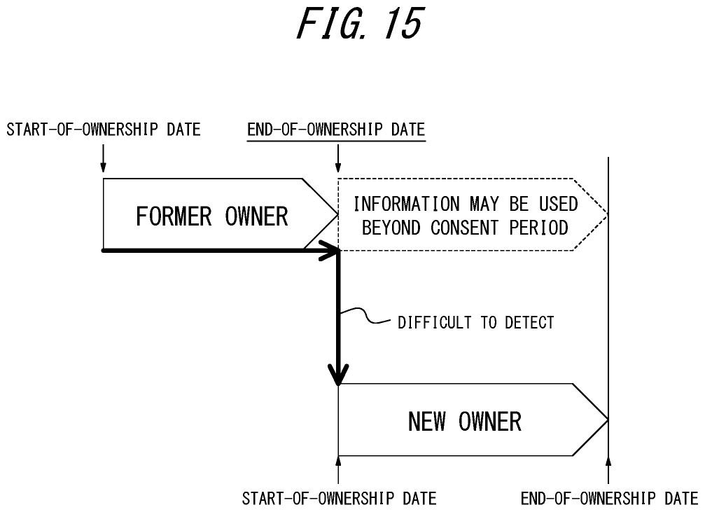

### DETAILED DESCRIPTION

Hereinafter, some embodiments of the present disclosure will be described with reference to the drawings.

In the drawings, the same or corresponding portions are denoted by the same reference numerals. In the descriptions of the embodiments, detailed descriptions of the same or corresponding portions are omitted or simplified, as appropriate.

A first embodiment of the present disclosure will be described.

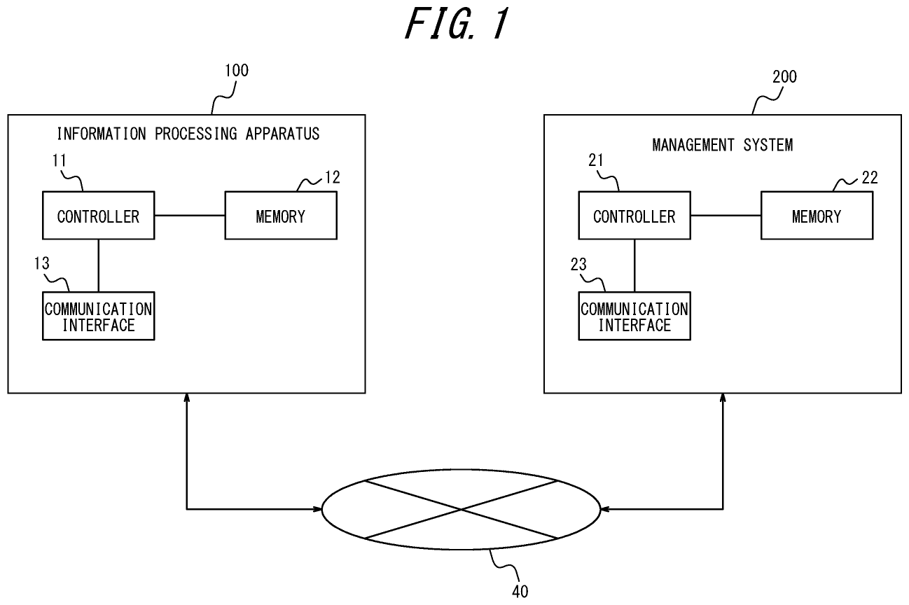

A configuration of a system according to the present embodiment will be described with reference to FIG. 1.

The system according to the present embodiment includes an information processing apparatus 100 and a management system 200.

The information processing apparatus 100 is installed in a facility such as a data center. The information processing apparatus 100 is a computer such as a server that belongs to a cloud computing system or another type of computing system. The information processing apparatus 100 can communicate with the management system 200 via a network 40.

The management system 200 is installed in a facility such as a data center. The management system 200 is a computer such as a server that belongs to a cloud computing system or another type of computing system. For example, the management system 200 is operated by a government agency that administers registration procedures related to vehicles, such as procedures for vehicle transfer registration, or by an agency that administers the registration procedures on behalf of the government agency (hereinafter also referred to collectively as the “government agency, etc.”).

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

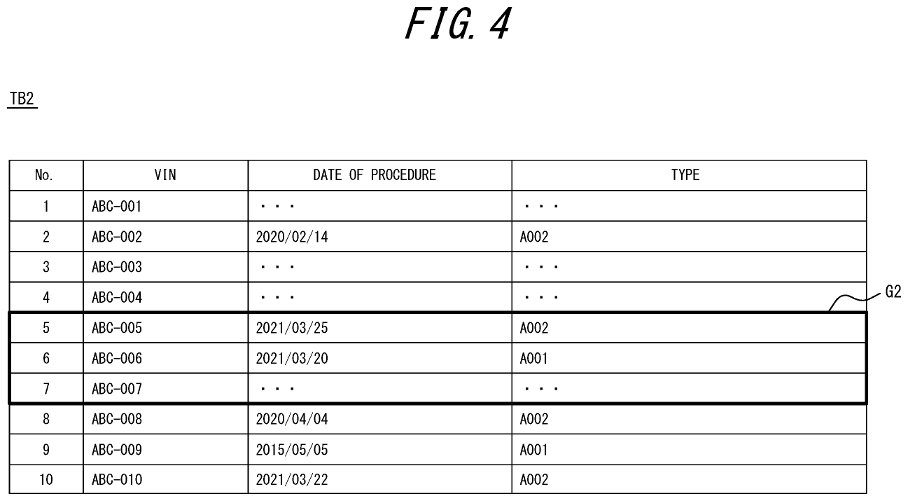

With reference to FIGS. 1 and 4, an outline of the present embodiment will be described.

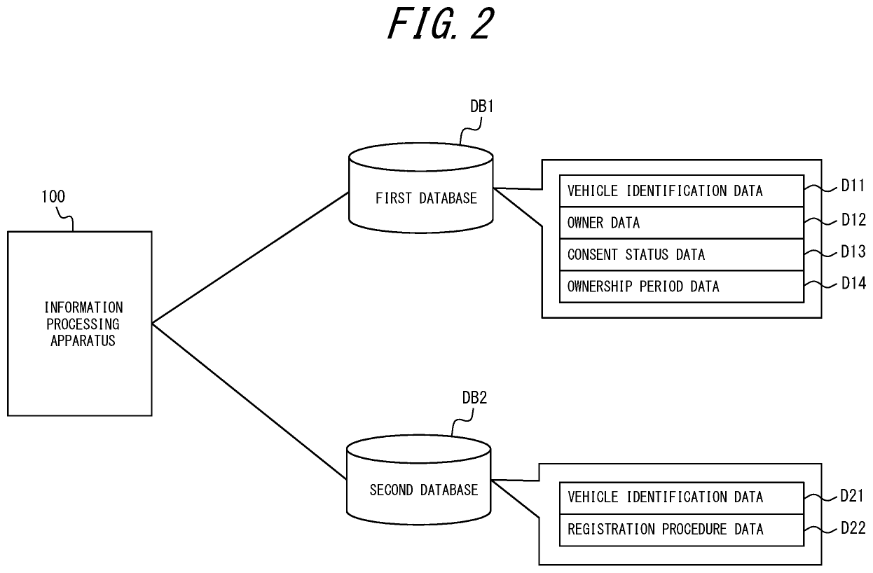

The information processing apparatus 100 according to the present embodiment uses the data stored in a first database DB1 and a second database DB2, as illustrated in FIG. 2.

The information processing apparatus 100 refers to the first database DB1 and acquires inquiry vehicle data. In the first database DB1, vehicle identification data D11 and consent status data D13 are stored for each of a plurality of vehicles, and ownership period data D14 is stored for each of vehicles in a first vehicle group G1 among the plurality of vehicles. Vehicle identification data D11 is data that identifies a vehicle, specifically, data that indicates a vehicle identification number (VIN). Consent status data D13 indicates whether an owner consented to disclosure of information obtained from a vehicle. Ownership period data D14 indicates a date on which an owner terminated the ownership as an end-of-ownership date. The information processing apparatus 100 acquires, for each of vehicles, other than the vehicles in the first vehicle group G1 among the plurality of vehicles, in a second vehicle group G2 for which the corresponding consent status data D13 indicates that an owner consented to disclosure of information obtained from a vehicle, the corresponding vehicle identification data D11 as inquiry vehicle data. The information processing apparatus 100 may refer to the first database DB1 at any point in time to acquire inquiry vehicle data. However, in the present embodiment, the information processing apparatus 100 refers to the first database DB1 for each unit period, specifically every month, to acquire inquiry vehicle data.

The information processing apparatus 100 transmits request data including the inquiry vehicle data acquired to the management system 200 that manages the second database DB2. Although the management system 200 is a system operated by the government agency, etc. in the present embodiment, it may be a system operated by other organizations, such as private companies. The second database DB2 stores data indicating, for each vehicle of the plurality of vehicles, the dates on which one or more types of registration procedures were performed and the type of registration procedure performed. Although the information processing apparatus 100 may transmit request data at any point in time, it transmits request data for each unit period, specifically, every month in the present embodiment.

The information processing apparatus 100 receives response data from the management system 200. The response data is transmitted in response to the request data and includes vehicle identification data D21 for vehicles among the vehicles in the second vehicle group G2 for which a certain type of registration procedure has been performed within a reference period. In the present embodiment, the response data includes vehicle identification data D21 for a vehicle for which a registration procedure that is likely to involve an owner change has been performed within the reference period. In the present embodiment, a registration procedure for owner's name change and owner's address change, or a deletion registration procedure, which is a registration procedure for temporary discontinuation of use, export, or dismantling, corresponds to a registration procedure that is likely to involve an owner change. The reference period may be any period of time. However, in the present embodiment, the reference period is a unit period one unit before the unit period in which request data is transmitted. Specifically, the reference period is the previous month of the month to which a request date, which is the transmission date of the request data, belongs. Although the unit period is one month in the present embodiment, it may be shorter than one month, for example, one week. In that case, the reference period is the week preceding the week to which the transmission date of the request data belongs.

The information processing apparatus 100 calculates, for each of those vehicles identified by the vehicle identification data D21 included in the response data received, the corresponding end-of-ownership date based on the reference period.

According to the present embodiment, even in a case in which it is difficult to detect an owner change, an end-of-ownership date can be calculated according to the information that a certain type of registration procedure, such as a registration procedure for owner's name change and owner's address change or a deletion registration procedure, has been performed within the reference period. As a result, the consent period can be properly managed, making it easier to avoid undesirable disclosure of information obtained from the vehicle.

In the present embodiment, the first database DB1 stores dummy period data D15 for each of vehicles in vehicle groups other than the first vehicle group G1 among the plurality of vehicles. Dummy period data D15 indicates a fixed date instead of an end-of-ownership date in the same format as the ownership period data D14. The format of the end-of-ownership date indicated by the ownership period data D14 is “yyyy/mm/dd”. Accordingly, the format of the fixed date indicated by the dummy period data D15 is also “yyyy/mm/dd”. The fixed date may be any date that has zero or very low probability of being an end-of-ownership date. However, in the present embodiment, the fixed date is “9999/12/31”. In the present embodiment, the dummy period data D15 is used for the vehicles for which the ownership period data D14 is not stored in the first database DB1. However, instead of the dummy period data D15, data indicating “---” or “N/A” may be stored in the first database DB1. The information processing apparatus 100 refers to the first database DB1 and identifies, as the vehicles in the second vehicle group G2 from among the plurality of vehicles, a group of vehicles for which the corresponding consent status data D13 indicates that owners consented to disclosure of information obtained from vehicles and for which the corresponding dummy period data D15 indicates the fixed date.

In the present embodiment, the ownership period data D14 not only indicates an end-of-ownership date, but also indicates a date on which an owner started ownership as a start-of-ownership date. The dummy period data D15 not only indicates the fixed date, instead of an end-of-ownership date, in the same format as the ownership period data D14, but also indicates a start-of-ownership date in the same format as the ownership period data D14.

In the present embodiment, the first database DB1 further stores owner data D12 for each vehicle of the plurality of vehicles. Although owner data D12 indicates an owner's name and an owner's address in the present embodiment, it may be data that identifies an owner, for example, data indicative of a customer number.

A configuration of the information processing apparatus 100 according to the present embodiment will be described with reference to FIG. 1.

The information processing apparatus 100 includes a controller 11, a memory 12, and a communication interface 13.

The controller 11 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 11 executes processes related to operations of the information processing apparatus 100 while controlling components of the information processing apparatus 100.

The memory 12 includes at least one semiconductor memory, at least one magnetic memory, at least one optical memory, or any combination thereof. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 12 functions as, for example, a main memory, an auxiliary memory, or a cache memory. The memory 12 stores data to be used for the operations of the information processing apparatus 100 and data obtained by the operations of the information processing apparatus 100. Although the first database DB1 is constructed in the memory 12 in the present embodiment, it may be constructed in an external storage and connected to the information processing apparatus 100.

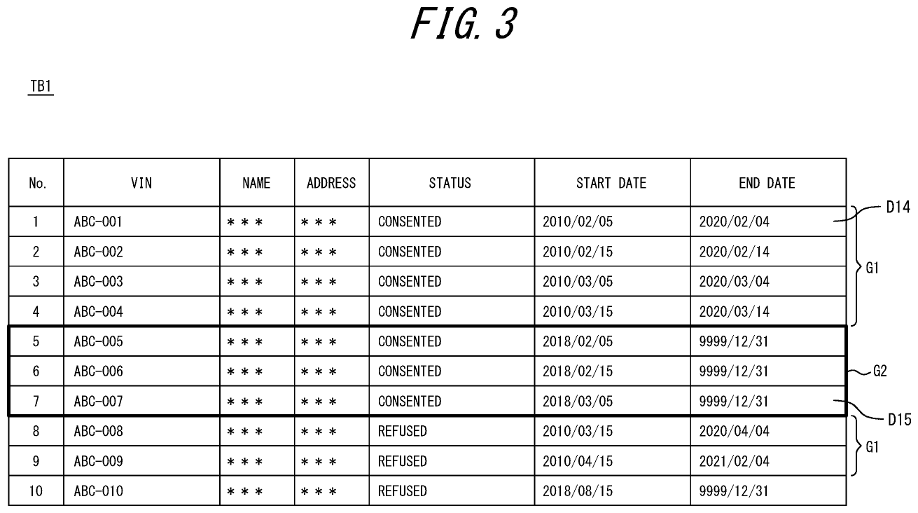

As described above, in the first database DB1, vehicle identification data D11 and consent status data D13 are stored for each vehicle of the plurality of vehicles, and ownership period data D14 is stored for each of the vehicles in the first vehicle group G1 among the plurality of vehicles. Specifically, the first database DB1 stores a table TB1 as illustrated in FIG. 3.

In the example illustrated in FIG. 3, the table TB1 contains “VIN”, “Name”, “Address”, “Status”, “Start Date”, and “End Date” columns. In the “VIN” column, vehicle identification data D11 is stored.

Specifically, in the “VIN” column, a vehicle identification number is stored. In the “Name” and “Address” columns, owner data D12 is stored. Specifically, in the “Name” column, an owner's name is stored. In the “Address” column, an owner's address is stored. In the “Status” column, consent status data D13 is stored. Specifically, in the “Status” column, a “consented” or “refused” flag is stored. A “consented” flag indicates that the owner consented to disclosure of information obtained from the vehicle. A “refused” flag indicates that the owner refused to allow such disclosure of information. For example, if the service provider cannot know of the fact that a vehicle has been transferred from the former owner to the new owner via a used car dealer, a “consented” or “refused” flag indicative of the intention of the former owner remains stored in the “Status” column for that vehicle. In the “Start Date” and “End Date” columns, ownership period data D14 or dummy period data D15 is stored. Specifically, in the “Start Date” column, a start-of-ownership date is stored. In the “End Date” column, an end-of-ownership date or the fixed date is stored. For example, if the service provider cannot know of the fact that a vehicle has been transferred from the former owner to the new owner via a used car dealer, the fixed date remains stored in the “End Date” column for that vehicle. In other words, the dummy period data D15 remains stored. On the other hand, if the service provider can know of the fact that a vehicle has been transferred from the former owner to the new owner via an authorized dealer, the fixed date that has been stored in the “End Date” column for that vehicle is overwritten by the service provider with an end-of-ownership date. In other words, the dummy period data D15 is overwritten and ownership period data D14 is stored instead.

In the example illustrated in FIG. 3, six vehicles identified by the vehicle identification numbers “ABC-001” to “ABC-004” and “ABC-008” to “ABC-009” correspond to vehicles in the first vehicle group G1. Three vehicles identified by the vehicle identification numbers “ABC-005” to “ABC-007” correspond to vehicles in the second vehicle group G2.

The communication interface 13 includes at least one interface for communication. The interface for communication is, for example, a LAN interface. The communication interface 13 receives data to be used for the operations of the information processing apparatus 100, and transmits data obtained by the operations of the information processing apparatus 100.

The functions of the information processing apparatus 100 are realized by execution of a program according to the present embodiment by a processor serving as the controller 11. That is, the functions of the information processing apparatus 100 are realized by software. The information processing program causes a computer to execute the operations of the information processing apparatus 100, thereby causing the computer to function as the information processing apparatus 100. That is, the computer executes the operations of the information processing apparatus 100 in accordance with the program to thereby function as the information processing apparatus 100.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the information processing apparatus 100 may be realized by a programmable circuit or a dedicated circuit serving as the controller 11. That is, some or all of the functions of the information processing apparatus 100 may be realized by hardware.

A configuration of the management system 200 according to the present embodiment will be described with reference to FIG. 1.

The management system 200 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 21 executes processes related to operations of the management system 200 while controlling components of the management system 200.

The memory 22 includes at least one semiconductor memory, at least one magnetic memory, at least one optical memory, or any combination thereof. The semiconductor memory is, for example, RAM or ROM. The RAM is, for example, SRAM or DRAM. The ROM is, for example, EEPROM. The memory 22 functions as, for example, a main memory, an auxiliary memory, or a cache memory. The memory 22 stores data to be used for the operations of the management system 200 and data obtained by the operations of the management system 200. Although the second database DB2 is constructed in the memory 22 in the present embodiment, it may be constructed in an external storage and connected to the management system 200.

In the second database DB2, for each vehicle of the plurality of vehicles, data indicating the date on which one or more types of registration procedures were performed as a date of procedure and the type of registration procedure performed is stored as registration procedure data D22. In the present embodiment, vehicle identification data D21 is further stored in the second database DB2 for each vehicle of the plurality of vehicles. Vehicle identification data D21 is data that identifies a vehicle, specifically, data that indicates the same vehicle identification number as indicated by the vehicle identification data D11. Specifically, the second database DB2 stores a table TB2 as illustrated in FIG. 4.

In the example illustrated in FIG. 4, the table TB2 contains “VIN”, “Date of Procedure”, and “Type” columns. In the “VIN” column, vehicle identification data D21 is stored. Specifically, in the “VIN” column, a vehicle identification number is stored. In the “Date of Procedure” and “Type” columns, registration procedure data D22 is stored. Specifically, in the “Date of Procedure” column, a date of procedure is stored. In the “Type” column, a value indicating the type of registration procedure performed on the date of procedure is stored. As a specific value, “A001” indicates a registration procedure for owner's name change and owner's address change. “A002” indicates a deletion registration procedure.

The communication interface 23 includes at least one interface for communication. The interface for communication is, for example, a LAN interface. The communication interface 23 receives data to be used for the operations of the management system 200, and transmits data obtained by the operations of the management system 200.

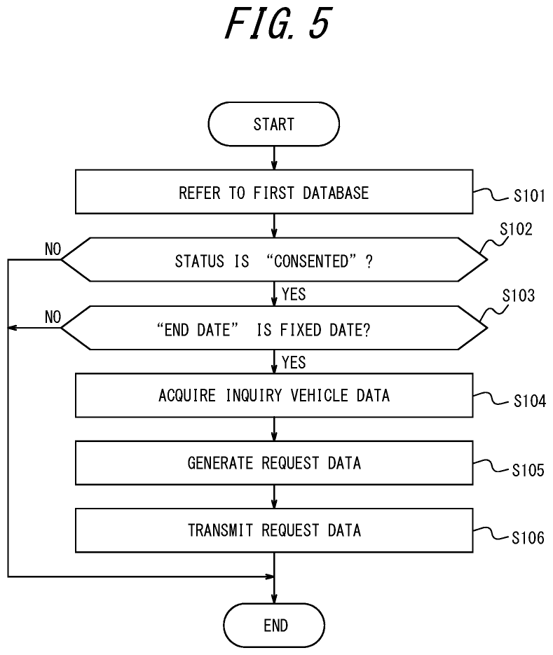

Operations of the system according to the present embodiment will be described with reference to FIGS. 5 to 8. These operations correspond to an information processing method according to the present embodiment. The information processing method according to the present embodiment can be roughly divided into first through fourth phases. In the first phase of the present embodiment, the information processing apparatus 100 transmits request data to the management system 200. In the second phase of the present embodiment, the management system 200 detects a registration procedure for owner's name change and owner's address change. In the third phase of the present embodiment, the management system 200 detects a deletion registration procedure. In the fourth phase of the present embodiment, the information processing apparatus 100 calculates an end-of-ownership date after receiving response data from the management system 200.

A process in the first phase according to the present embodiment will be described with reference to FIG. 5.

As described below, in steps S101 to S104, the controller 11 of the information processing apparatus 100 refers to the first database DB1 and acquires inquiry vehicle data.

In step S101, the controller 11 of the information processing apparatus 100 refers to the first database D1. Specifically, the controller 11 refers to the table TB1 as illustrated in FIG. 3.

In step S102, the controller 11 of the information processing apparatus 100 determines, for each vehicle of the plurality of vehicles, whether the corresponding consent status data D13 indicates that the owner consented to disclosure of information obtained from the vehicle (hereinafter also referred to as the “disclosure of information”). Specifically, the controller 11 determines whether a “consented” flag is stored in the “Status” column of the table TB1 for each vehicle. If the corresponding consent status data D13 for any vehicle does not indicate that the owner consented to the disclosure of information, i.e., no vehicle has a “consented” flag stored in the “Status” column of the table TB1, the controller 11 terminates the process. In the example illustrated in FIG. 3, “consented” flags are stored in the “Status” column for seven vehicles identified by the vehicle identification numbers “ABC-001” to “ABC-007”. Then, for these seven vehicles, the controller 11 determines that the corresponding consent status data D13 indicates that the owner consented to the disclosure of information.

In step S103, the controller 11 of the information processing apparatus 100 determines whether the fixed date is indicated by the corresponding dummy period data D15 for each of those vehicles for which it is determined in step S102 that the corresponding consent status data D13 indicates that the owner consented to the disclosure of information. Specifically, the controller 11 determines, for each of those vehicles for which a “consented” flag is stored in the “Status” column of the table TB1, whether the fixed date is stored in the “End Date” column of the table TB1. If the fixed date is not indicated by the corresponding dummy period data D15 for any vehicle, i.e., if none of the vehicles has a “consented” flag stored in the “Status” column and the fixed date stored in the “End Date” column in the table TB1, the controller 11 terminates the process. In the example illustrated in FIG. 3, the fixed date is stored in the “End Date” column for three vehicles identified by the vehicle identification numbers “ABC-005” to “ABC-007” out of the seven vehicles identified by the vehicle identification numbers “ABC-001” to “ABC-007”. Then, for these three vehicles, the controller 11 determines that the fixed date is indicated by the corresponding dummy period data D15.

In step S104, the controller 11 of the information processing apparatus 100 acquires, for each of vehicles in a second vehicle group G2, the corresponding vehicle identification data D11 as inquiry vehicle data. The vehicles in the second vehicle group G2 are those vehicles among the plurality of vehicles for which it is determined in step S102 that the corresponding consent status data D13 indicates that the owner consented to the disclosure of information, and for which it is determined in step S103 that the fixed date is indicated by the corresponding dummy period data D15. Specifically, for the vehicles in the second vehicle group G2, the controller 11 acquires respective vehicle identification numbers stored in the “VIN” column of the table TB1. The controller 11 acquires the vehicle identification numbers of the vehicles in the second vehicle group G2 as the inquiry vehicle data. In the example illustrated in FIG. 3, the controller 11 stores the vehicle identification numbers “ABC-005” to “ABC-007” in the memory 12 as the inquiry vehicle data.

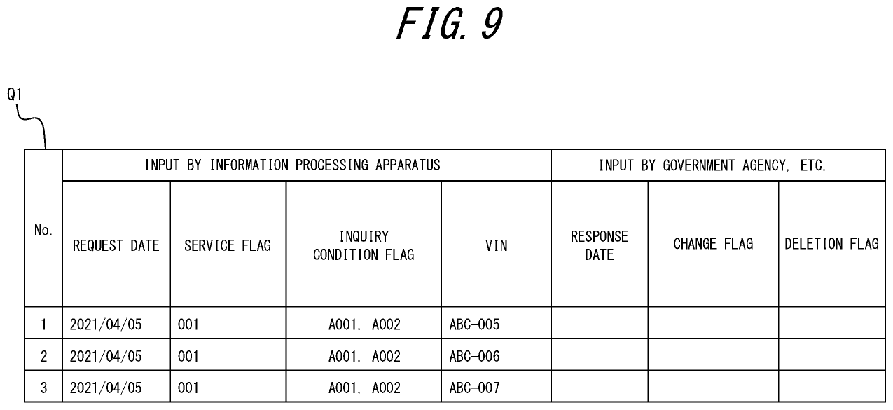

In step S105, the controller 11 of the information processing apparatus 100 generates request data including the inquiry vehicle data acquired in step S104. Specifically, the controller 11 generates request data including the inquiry vehicle data stored in the memory 12 as a file Q1 as illustrated in FIG. 9. In the present embodiment, the controller 11 further includes inquiry condition data in the request data. The inquiry condition data specifies the type of registration procedure. In the example illustrated in FIG. 9, the controller 11 includes the vehicle identification numbers “ABC-005” to “ABC-007” as the inquiry condition data in the file Q1. The controller 11 further includes inquiry condition flags indicating registration procedure types “A001” and “A002” as the inquiry condition data in the file Q1. In addition to the vehicle identification numbers and the inquiry condition flags, the controller 11 further includes a request date and a service flag in the file Q1, as illustrated in FIG. 9. A request date is the date on which the file Q1 is transmitted from the information processing apparatus 100 to the management system 200. In the example illustrated in FIG. 9, all of the vehicles have a request date of “2021/04/05”. Accordingly, the file Q1 is transmitted from the information processing apparatus 100 to the management system 200 on Apr. 5, 2021. In this case, the unit period for which the request data is transmitted is the month of April 2021. A service flag indicates the type of service related to a vehicle identified by the corresponding vehicle identification number. In the present embodiment, the vehicle-related service is a service that provides data by obtaining individual consent from owners to disclosure of information obtained from vehicles (hereinafter also referred to as the “vehicle data provision service”). Examples of the information obtained from vehicles include driving data or vehicle inspection data. In the example illustrated in FIG. 9, the value “001” of the service flag corresponding to the vehicle identification numbers “ABC-005” to “ABC-007” indicates the vehicle data provision service.

In step S106, the communication interface 13 of the information processing apparatus 100 transmits the request data generated in step S105 to the management system 200. In the present embodiment, the controller 11 of the information processing apparatus 100 refers to the first database DB1 and acquires inquiry vehicle data for each unit period. The unit period is a month, as described above. In other words, the controller 11 refers to the first database DB1 once a month to acquire inquiry vehicle data. Accordingly, the communication interface 13 transmits request data once a month. In the example illustrated in FIG. 9, the communication interface 13 transmits, as the inquiry to be made in April 2021, the file Q1 generated by the controller 11 to the management system 200 on Apr. 5, 2021.

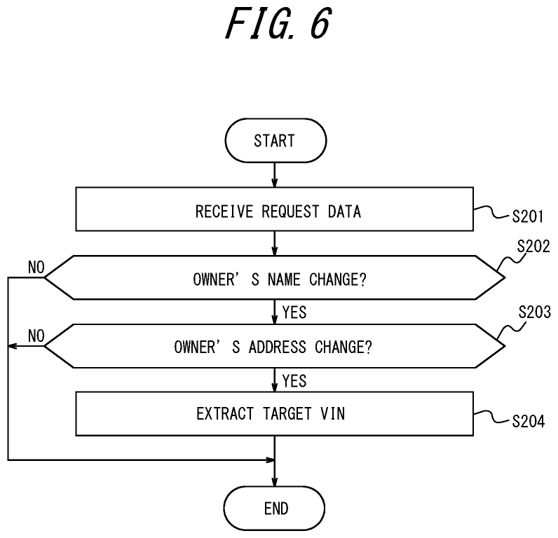

A process in the second phase according to the present embodiment will be described with reference to FIG. 6.

In step S201, the communication interface 23 of the management system 200 receives the file Q1 transmitted from the information processing apparatus 100 as the request data. In the example illustrated in FIG. 9, since the file Q1 includes inquiry condition flags indicating the registration procedure type “A001” as the inquiry condition data, the controller 21 of the management system 200 stores the file Q1 in the memory 22 and then starts detection of changed information in steps S202 to S204. The detection of changed information refers to the operations of detecting a registration procedure for owner's name change and owner's address change.

In step S202, the controller 21 of the management system 200 refers to the second database DB2 to determine, for each of those vehicles identified by the inquiry vehicle data included in the file Q1 received in step S201, that is, for each of the vehicles in the second vehicle group G2, whether a registration procedure for owner's name change has been performed within a reference period. In the present embodiment, the reference period is the previous month of the month to which the transmission date of the file Q1 belongs. In the example illustrated in FIG. 9, the transmission date of the file Q1 is Apr. 5,2021. Accordingly, the reference period is the month of March 2021. With reference to the table TB2, if a registration procedure for owner's name change has not been performed for any of the vehicles in the second vehicle group G2 during March 2021, the controller 21 terminates the process. In the example illustrated in FIG. 4, for the vehicle identified by the vehicle identification number “ABC-006”, “A001” is stored in the “Type” column and “2021/03/20” in the “Date of Procedure” column in the table TB2. Then, the controller 21 determines that a registration procedure for owner's name change has been performed for this vehicle within the reference period.

In step S203, the controller 21 of the management system 200 refers to the second database DB2 to determine, for each of those vehicles identified by the inquiry vehicle data included in the file Q1 received in step S201, that is, for each of the vehicles in the second vehicle group G2, whether owner's address change has been performed within the reference period. In the example illustrated in FIG. 9, with reference to the table TB2, if a registration procedure for owner's address change has not been performed for any of the vehicles in the second vehicle group G2 during March 2021, the controller 21 terminates the process. In the example illustrated in FIG. 4, for the vehicle identified by the vehicle identification number “ABC-006”, “A001” is stored in the “Type” column and “2021/03/20” in the “Date of Procedure” column in the table TB2. Then, for this vehicle, the controller 21 determines that a registration procedure for owner's address change has been performed within the reference period.

In the example illustrated in FIG. 4, it is assumed that a single registration procedure is performed to register both owner's name change and owner's address change. However, separate registration procedures may be performed for owner's name change and for owner's address change. In this case, one inquiry condition flag indicating a registration procedure for owner's name change and another inquiry condition flag indicating a registration procedure for owner's address change may be included in the file Q1 as the inquiry condition data. The table TB2 may contain two records with “2021/03/20” stored in the “Date of Procedure” column for the vehicle identified by the vehicle identification number “ABC-006”. The “Type” column for one of the two records may contain a value indicating the registration procedure for owner's name change, and the “Type” column for the other may contain a value indicating the registration procedure for owner's address change.

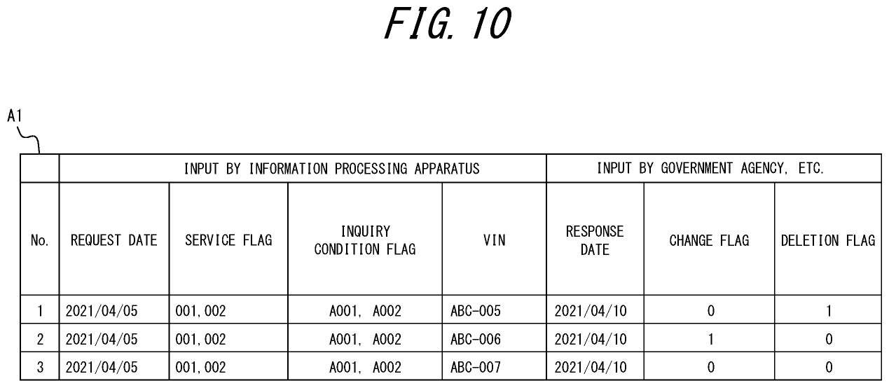

In step S204, the controller 21 of the management system 200 extracts, as a target VIN, a vehicle identification number that identifies a vehicle for which it is determined in step S202 that a registration procedure for owner's name change has been performed within the reference period, and for which it is determined in step S203 that a registration procedure for owner's address change has been performed within the reference period. Specifically, the controller 21 converts the file Q1 stored in the memory 22 into a file A1 as illustrated in FIG. 10 by adding a change flag to the file Q1. A change flag indicates “0” if a registration procedure for owner's name change and owner's address change has not been performed for a vehicle identified by the corresponding vehicle identification number, and “1” if a registration procedure for owner's name change and owner's address change has been performed for the vehicle. In the example illustrated in FIG. 10, the controller 21 adds a change flag indicating “1” for the vehicle identified by the vehicle identification number “ABC-006” extracted as a target VIN. The controller 21 adds a change flag indicating “0” for the vehicles identified by the vehicle identification numbers “ABC-005” and “ABC-007” as non-target VINs, which are VINs other than the target VIN.

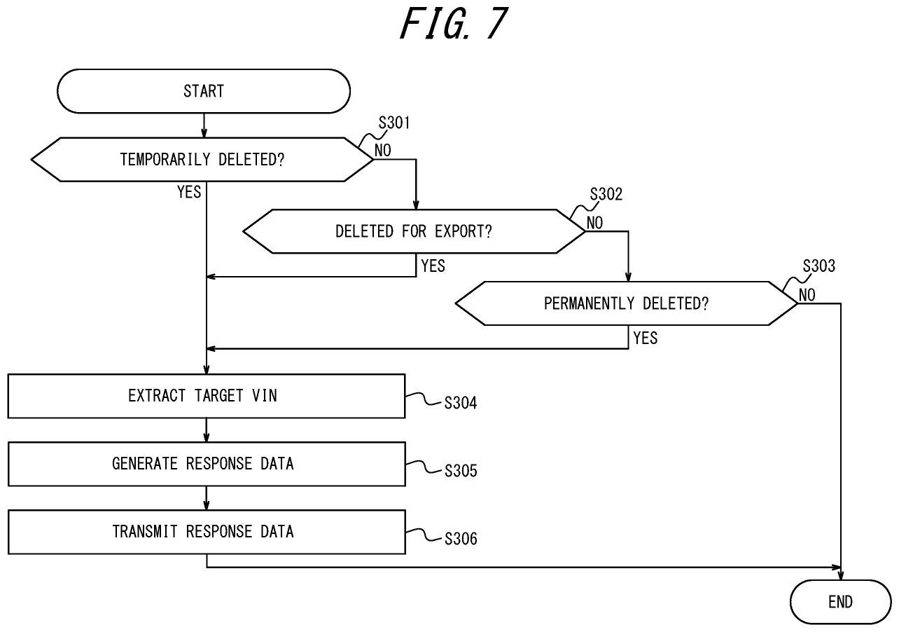

A process in the third phase according to the present embodiment will be described with reference to FIG. 7.

In the example illustrated in FIG. 9, the file Q1 also includes inquiry condition flags indicating the registration procedure type “A002” as the inquiry condition data. Then, following the process in the second phase, the controller 21 of the management system 200 starts detection of deletion registration in steps S301 to S305. The detection of deletion registration refers to the operations of detecting a deletion registration procedure. The detection of deletion registration may be performed instead of or in addition to the detection of changed information in the second phase. In the present embodiment, the detection of deletion registration is performed in addition to the detection of changed information.

In steps S301 to S303, the controller 21 of the management system 200 refers to the second database DB2 to determine, for each of those vehicles identified by the inquiry vehicle data included in the file Q1 received in step S201, that is, for each of the vehicles in the second vehicle group G2, whether a registration procedure for temporary discontinuation of use, export, or dismantling has been performed within the reference period. In the example illustrated in FIG. 9, with reference to the table TB2, if a registration procedure for temporary discontinuation of use, export, or dismantling has not been performed for any of the vehicles in the second vehicle group G2 during March 2021, the controller 21 terminates the process. In the example illustrated in FIG. 4, for the vehicle identified by the vehicle identification number “ABC-005”, “A002” is stored in the “Type” column and “2021/03/25” in the “Date of Procedure” column in the table TB2. Then, the controller 21 determines that a registration procedure for temporary discontinuation of use, export, or dismantling has been performed for this vehicle within the reference period.

In the example illustrated in FIG. 4, for simplicity of explanation, registration procedures for temporary discontinuation of use, export, and dismantling are not distinguished from each other. However, in the present embodiment, these procedures are distinguished as three different registration procedures. Thus, the file Q1 includes, as the inquiry condition data, an inquiry condition flag indicating a registration procedure for temporary discontinuation of use, an inquiry condition flag indicating a registration procedure for export, and an inquiry condition flag indicating a registration procedure for dismantling. In the table TB2, for the vehicle identified by the vehicle identification number “ABC-005”, “2021/03/25” is stored in the “Date of Procedure” column, and a value indicating a registration procedure for temporary discontinuation of use, a value indicating a registration procedure for export, or a value indicating a registration procedure for dismantling is stored in the “Type” column.

In step S304, the controller 21 of the management system 200 extracts, as a target VIN, a vehicle identification number that identifies a vehicle for which it is determined in steps S301 to S303 that a registration procedure for temporary discontinuation of use, export, or dismantling has been performed within the reference period. Specifically, the controller 21 updates the file A1 stored in the memory 22 by adding a deletion flag to the file A1. A deletion flag indicates “0” if a deletion registration procedure has not been performed for a vehicle identified by the corresponding vehicle identification number, and “1” if a deletion registration procedure has been performed for the vehicle. In the example illustrated in FIG. 10, the controller 21 adds a deletion flag indicating “1” for the vehicle identified by the vehicle identification number “ABC-005” extracted as a target VIN. The controller 21 adds a deletion flag indicating “0” for the vehicles identified by the vehicle identification numbers “ABC-006” and “ABC-007” as non-target VINs, which are VINs other than the target VIN.

In step S305, the controller 21 of the management system 200 generates response data including the vehicle identification data D21 for vehicles among the vehicles in the second vehicle group G2 for which a certain type of registration procedure has been performed within the reference period. Specifically, the controller 21 updates the file A1 stored in the memory 22 as response data by adding a response date to the file A1. A response date is the date on which the file A1 is transmitted from the management system 200 to the information processing apparatus 100. In the example illustrated in FIG. 10, all of the vehicles have a response date of “2021/04/10”. Accordingly, the file A1 is transmitted from the management system 200 to the information processing apparatus 100 on Apr. 10, 2021.

In step S306, the communication interface 23 of the management system 200 transmits the response data generated in step S306 to the information processing apparatus 100 via the network 40. In the example illustrated in FIG. 10, the communication interface 23 transmits the file A1 stored in the memory 22 to the information processing apparatus 100 on Apr. 10, 2021.

In the present embodiment, the detection of deletion registration is performed after completion of the detection of changed information. However, the detection of changed information and the detection of deletion registration may be performed in reverse order or simultaneously.

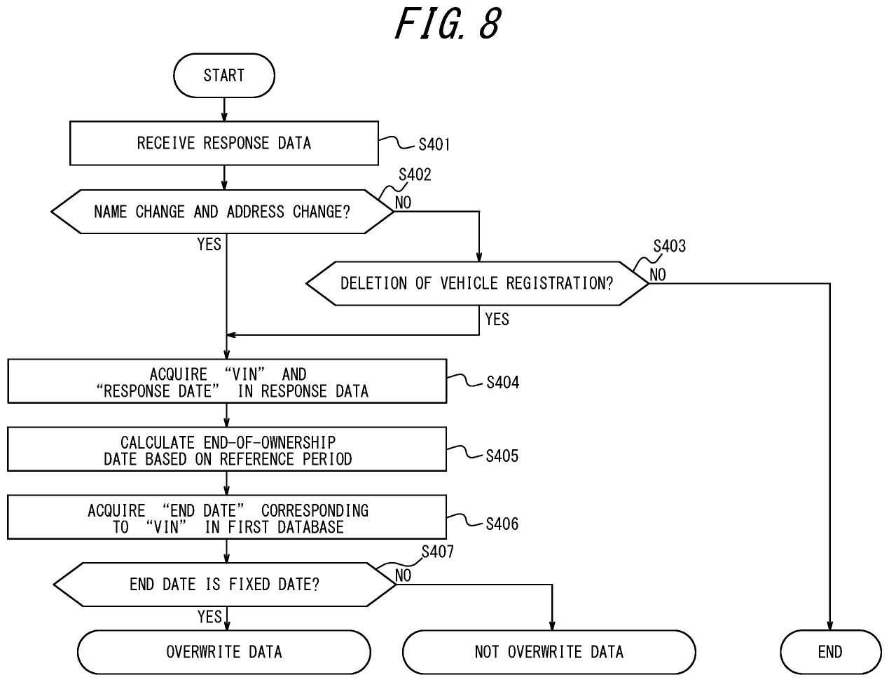

A process in the fourth phase according to the present embodiment will be described with reference to FIG. 8.

In step S401, the communication interface 13 of the information processing apparatus 100 receives the response data transmitted from the management system 200. Specifically, the communication interface 13 receives the file A1 transmitted in step S306 as the response data.

In step S402, the controller 11 of the information processing apparatus 100 refers to the response data received by the communication interface 13 and determines, for each of the vehicles in the second vehicle group G2, whether a registration procedure for owner's name change and owner's address change has been performed within the reference period. If it is determined that a registration procedure for owner's name change and owner's address change has not been performed within the reference period for any of the vehicles in the second vehicle group G2, the controller 11 proceeds to step S403. Specifically, with reference to the file A1, if the corresponding change flags indicate “0” for all of the vehicles in the second vehicle group G2, the controller 11 proceeds to step S403. On the other hand, if it is determined that a registration procedure for owner's name change and owner's address change has been performed within the reference period for at least one of the vehicles in the second vehicle group G2, the controller 11 proceeds to step S404. Specifically, with reference to the file A1, if the corresponding change flag indicates “1” for at least one of the vehicles in the second vehicle group G2, the controller 11 proceeds to step S404. In the example illustrated in FIG. 10, a change flag in the file A1 indicates “1” for the vehicle identified by the vehicle identification number “ABC-006”. Then, the controller 21 determines that a registration procedure for owner's name change has been performed for this vehicle within the reference period.

In step S403, the controller 11 of the information processing apparatus 100 refers to the response data and determines, for each of the vehicles in the second vehicle group G2, whether a deletion registration procedure has been performed within the reference period. If it is determined that a deletion registration procedure has not been performed for any of the vehicles in the second vehicle group G2 within the reference period, the controller 11 terminates the process. Specifically, with reference to the file A1, if the corresponding deletion flags indicate “0” for all of the vehicles in the second vehicle group G2, the controller 11 terminates the process. On the other hand, if it is determined that a deletion registration procedure has been performed within the reference period for at least one of the vehicles in the second vehicle group G2, the controller 11 proceeds to step S404. Specifically, with reference to the file A1, if the corresponding deletion flag indicates “1” for at least one of the vehicles in the second vehicle group G2, the controller 11 proceeds to step S404. In the example illustrated in FIG. 10, a deletion flag in the file A1 indicates “1” for the vehicle identified by the vehicle identification number “ABC-005”. Then, the controller 11, supposing that it has proceeded to step S403, determines that a deletion registration procedure has been performed for this vehicle within the reference period.

In step S404, the controller 11 of the information processing apparatus 100 refers to the response data and acquires vehicle identification data D21 for the following vehicles among the vehicles in the second vehicle group G2: (i) vehicles for which it is determined in step S402 that a registration procedure for owner's name change and owner's address change has been performed within the reference period; and (ii) vehicles for which it is determined in step S403 that a deletion registration procedure has been performed within the reference period. Specifically, the controller 11 refers to the file A1 and acquires the vehicle identification numbers for the vehicles with the corresponding change flags indicating “1” and the vehicles with the corresponding deletion flags indicating “1”, and the corresponding response date. In the example illustrated in FIG. 10, the controller 11 acquires the vehicle identification numbers “ABC-005” and “ABC-006” and the response date “2021/04/10”.

In step S405, the controller 11 of the information processing apparatus 100 calculates, for each of those vehicles identified by the vehicle identification data D21 included in the response data received by the communication interface 13, the corresponding end-of-ownership date based on the reference period. In the present embodiment, the controller 11 calculates, for each of those vehicles identified by the vehicle identification data D21 included in the response data, the last day of the reference period as the corresponding end-of-ownership date. Specifically, for those vehicles identified by the vehicle identification numbers acquired in step S404, the controller 11 calculates a date corresponding to the last day of the previous month of the month to which the response date acquired in step S404 belongs. In the example illustrated in FIG. 10, for the vehicles identified by the vehicle identification numbers “ABC-005” and “ABC-006, the corresponding end-of-ownership date is calculated to be the last day of the previous month of the month to which the date of Apr. 10, 2021 belongs, i.e., Mar. 31, 2021.

In step S406, the controller 11 of the information processing apparatus 100 refers to the first database DB1 and acquires, for each of those vehicles identified by the vehicle identification data D21 included in the response data, the corresponding ownership period data D14 or dummy period data D15. Specifically, the controller 11 acquires, for each of those vehicles identified by the vehicle identification numbers acquired in step S404, the date stored in the “End Date” column of the table TB1. In the example illustrated in FIG. 3, for each of the two vehicles identified by the vehicle identification numbers “ABC-005” and “ABC-006” in the table TB1, the fixed date “9999/12/31” stored in the “End Date” column is acquired.

In step S407, the controller 11 of the information processing apparatus 100 determines, for each of those vehicles identified by the vehicle identification data D21 included in the response data, whether the corresponding ownership period data D14 is stored in the first database DB1. If any dummy period data D15 has been acquired for at least one vehicle in step S406, the controller 11 determines that the corresponding ownership period data D14 is not stored in the first database DB1 for the at least one vehicle. Then, the controller 11 adds data indicating the end-of-ownership date calculated in step S405 to the first database DB1 as the corresponding ownership period data D14 for the at least one vehicle. In other words, the controller 11 updates the corresponding dummy period data D15 for the at least one vehicle by overwriting it with the data indicating the end-of-ownership date calculated in step S405. Specifically, if the date stored in the “End Date” column of the table TB1 is the fixed date for any of those vehicles identified by the vehicle identification numbers acquired in step S404, the controller 11 replaces the date stored in the “End Date” column with the end-of-ownership date calculated in step S405 for that vehicle. On the other hand, if corresponding dummy period data D15 has not been acquired in step S406 for any vehicle, the controller 11 determines that corresponding ownership period data D14 is stored in the first database DB1 for each of those vehicles identified by the vehicle identification data D21. Then, the controller 11 terminates the process. Specifically, the controller 11 terminates the process in a case in which it is determined that the date stored in the “End Date” column of the table TB1 is not the fixed date for any of those vehicles identified by the vehicle identification numbers acquired in step S404. In the example illustrated in FIG. 3, for each of the two vehicles identified by the vehicle identification numbers “ABC-005” and “ABC-006” in the table TB1, the “End Date” column is updated by overwriting the fixed date “9999/12/31” with the date “2021/03/31” calculated in step S405. In other words, in the present embodiment, the date calculated in step S405, that is, the date corresponding to the last day of the previous month of the month to which the response date belongs, is, instead of the actual date when a registration procedure was performed, considered to be an end-of-ownership date.

A time lag of one day or more may occur between the “request date” on which the request data is transmitted from the information processing apparatus 100 to the management system 200 and the time when the information processing apparatus 100 performs the determination in step S407. During this time lag period, for any of the vehicles in the second vehicle group G2, an owner change may occur and the dummy period data D15 corresponding to the vehicle may be changed to data indicating the actual end-of-ownership date. In such a case, the present embodiment makes it possible to prevent the actual end-of-ownership date for that vehicle from being overwritten with the end-of-ownership date calculated in step S405.

As described above, the information processing apparatus 100 according to the present embodiment receives response data from the management system 200, the response data including the vehicle identification data D21 for vehicles among the vehicles in the second vehicle group G2 for which a certain type of registration procedure has been performed within the reference period. The information processing apparatus 100 calculates, for each of those vehicles identified by the vehicle identification data D21 included in the response data received, the corresponding end-of-ownership date based on the reference period.

According to the present embodiment, an owner change can be substantially detected for the vehicles in the second vehicle group G2. Therefore, the consent period can be properly managed. As a result, it is easier to avoid undesirable disclosure of information obtained from a vehicle.

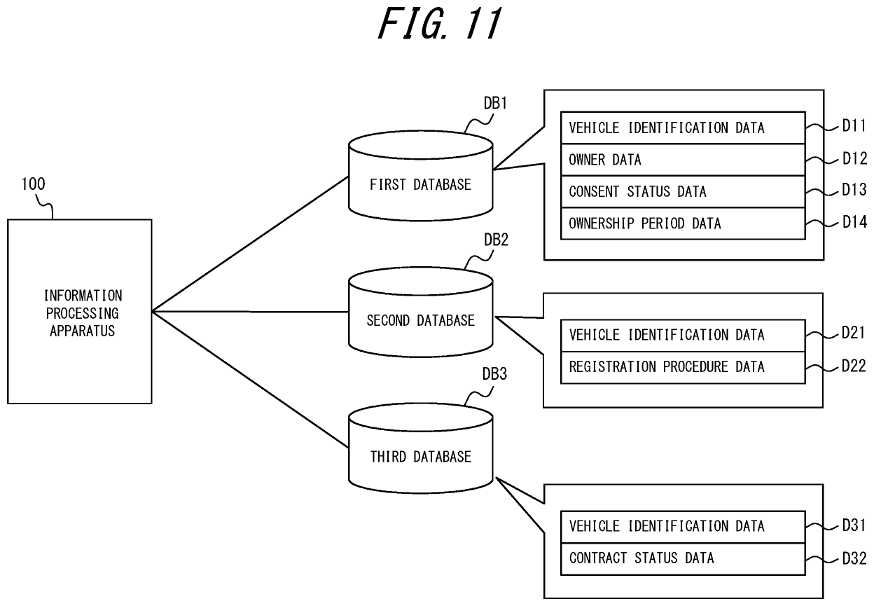

With reference to FIG. 11, an outline of a second embodiment, which is a variation of the present embodiment, will be described.

In the present embodiment, the information processing apparatus 100 also uses data stored in a third database DB3 in addition to the data stored in the first database DB1 and the second database DB2, as illustrated in FIG. 11.

In the third database DB3, vehicle identification data D31 and contract status data D32 are stored for each vehicle of the plurality of vehicles. Vehicle identification data D31 is data that identifies a vehicle, specifically, data that indicates the same vehicle identification number as indicated by the vehicle identification data D11. Contract status data D32 indicates whether an owner is under contract for a service associated with a vehicle. The information processing apparatus 100 refers to the third database DB3 and includes, for each of vehicles in a third vehicle group G3 among the plurality of vehicles for which the corresponding contract status data D32 indicates that an owner is under contract for a service associated with a vehicle (hereinafter also referred to as the “associated service”), the corresponding vehicle identification data in the request data as additional inquiry vehicle data while avoiding duplication. Although the third database DB3 is constructed in the memory 12 in the present embodiment, it may be constructed in an external storage and connected to the information processing apparatus 100.

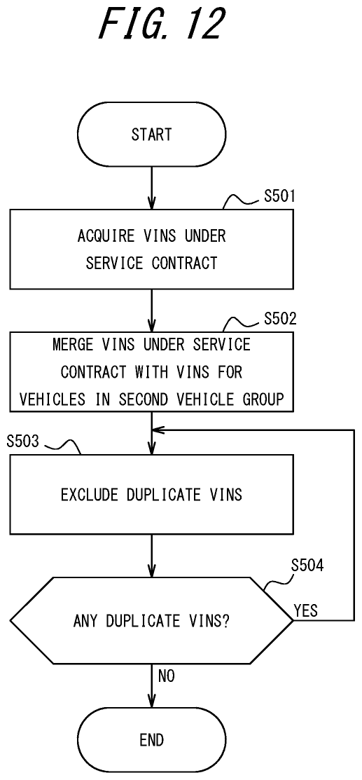

With reference to FIG. 12, a detailed processing procedure of step S105 illustrated in FIG. 5, which is included in a process in a first phase according to the present embodiment, will be explained below in terms of differences from the first embodiment.

In step S501, the controller 11 of the information processing apparatus 100 refers to the third database DB3 and acquires the vehicle identification numbers for the vehicles in the third vehicle group G3 (hereinafter also referred to as the “VINs under service contract”). Specifically, the controller 11 acquires the vehicle identification numbers for those vehicles for which contract status data D32 indicates that the owners are under contract for the associated service, for example, “ABC-005” to “ABC-007” and “ABC-010”, as the VINs under service contract.

In step S502, the controller 11 of the information processing apparatus 100 merges the VINs under service contract with the vehicle identification numbers for the vehicles in the second vehicle group G2 included in the inquiry vehicle data acquired in step S104. For example, the controller 11 generates a list of VINs under service contract including “ABC-005”, “ABC-006”, “ABC-007”, and “ABC-010”, and vehicle identification numbers for the vehicles in the second vehicle group G2 including “ABC-005”, “ABC-006”, and “ABC-007”.

In step S503, the controller 11 of the information processing apparatus 100 excludes one duplicate VIN from the list generated in step S502 in order to avoid duplication of VINs in the list. In step S504, the controller 11 determines whether there are any other duplicate VINs in the list. The controller 11 repeats the processing of steps S503 and S504 until it determines that there are no more duplicate VINs in the list. For example, the controller 11 removes from the list the VINs under service contract “ABC-005”, “ABC-006”, and “ABC-007” that overlap with the vehicle identification numbers for the vehicles in the second vehicle group G2 “ABC-005”, “ABC-006”, and “ABC-007”.

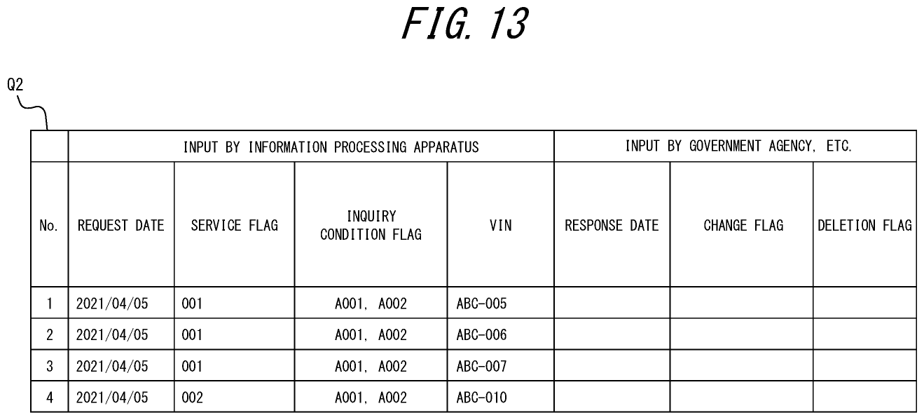

In the present embodiment, the list obtained by executing the processing from step S501 to S504 is included in the request data as the inquiry vehicle data. Specifically, the controller 11 generates the request data as a file Q2, as illustrated in FIG. 13. In the example illustrated in FIG. 13, in addition to the same inquiry condition data as in the example illustrated in FIG. 9, the controller 11 includes the vehicle identification number “ABC-010” as additional inquiry vehicle data in the file Q2. In the example illustrated in FIG. 13, all of the vehicles have a request date of “2021/04/05” as in the example illustrated in FIG. 9. Accordingly, the file Q2 is transmitted from the information processing apparatus 100 to the management system 200 on Apr. 5, 2021. In the present embodiment, the vehicle-related service includes an associated service in addition to the vehicle data provision service. In the example illustrated in FIG. 13, the associated service is indicated by the value “002” of the service flag corresponding to the vehicle identification number “ABC-010”.

In this way, by executing steps S501 to S504, the controller 11 includes, for each of vehicles in the third vehicle group G3 among the plurality of vehicles for which the corresponding contract status data D32 indicates that an owner is under contract for the service associated with a vehicle, the corresponding vehicle identification data D31 in the request data as additional inquiry vehicle data while avoiding duplication.

Although the operations illustrated in FIG. 12 is executed by the controller 11 of the information processing apparatus 100 in the present embodiment, they may be executed by an apparatus different from the information processing apparatus 100. Such apparatus may be, for example, a computer such as a server that belongs to a cloud computing system or another type of computing system that can communicate with the information processing apparatus 100 and the management system 200 via the network 40.

A detailed processing procedure of step S407 illustrated in FIG. 8, which is included in a process in a fourth phase according to the present embodiment, will be explained below in terms of differences from the first embodiment.

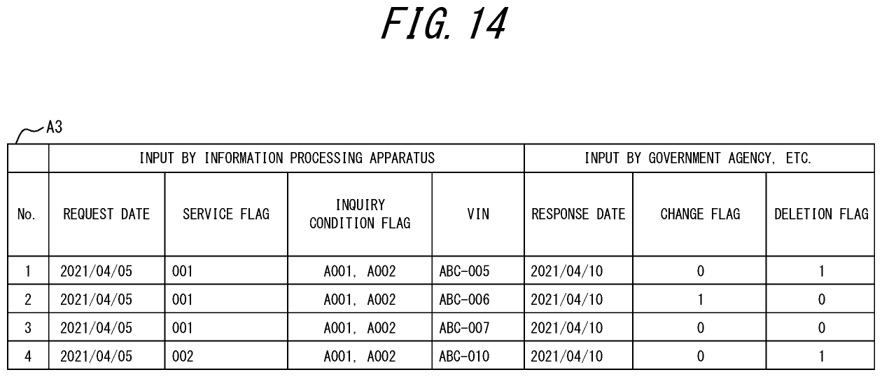

In the present embodiment, the communication interface 13 of the information processing apparatus 100 receives a file A3 as illustrated in FIG. 14 as response data in step S401. Through steps S402 to S406, the controller 11 of the information processing apparatus 100 updates, in step S407, the contract status data D32 stored in the third database DB3 for each of those vehicles identified by the vehicle identification data included in the response data. Specifically, with reference to the file A3, in a case in which the corresponding change flag or deletion flag indicates “1” for at least one vehicle in the third vehicle group G3, the controller 11 determines whether the corresponding contract status data D32 stored in the third database DB3 still indicates that the owner is under contract for the associated service. In the example illustrated in FIG. 14, the controller 11 determines that the corresponding change flags or deletion flags indicate “1” for the vehicles identified by the vehicle identification numbers “ABC-005”, “ABC-006”, and “ABC-010”. In this case, the controller 11 determines whether the contract status data D32 stored in the third database DB3 for each of these three vehicles still indicates that the owner is under contract for the associated service. For example, if it is determined that the contract status data D32 for the vehicle identified by the vehicle identification number “ABC-005” still indicates that the owner is under contract for the associated service, the controller 11 updates the contract status data D32 for this vehicle to data indicating that the owner is not under contract for the associated service.

As described above, the controller 11 of the information processing apparatus 100 according to the present embodiment updates the contract status data D32 stored in the third database DB3 for each of those vehicles identified by the vehicle identification data included in the response data received from the management system 200 to data indicating that the owner is not under contract for the associated service.

According to the present embodiment, an owner change can also be substantially detected for the vehicles in the third vehicle group G3. Therefore, for each of the vehicles in the third vehicle group G3, the contract status data D32 can be kept up to date and the contract period for the service associated with the vehicle can be properly managed. As a result, it is easier to avoid undesirable disclosure of information obtained from a vehicle.

The present disclosure is not limited to the embodiments described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. An information processing apparatus comprising:
a controller configured to refer to a first database in which vehicle identification data, consent status data, and ownership period data are stored, the vehicle identification data identifying each vehicle of a plurality of vehicles, the consent status data indicating whether, for each vehicle of the plurality of vehicles, an owner consented to disclosure of information obtained from a vehicle, and the ownership period data indicating a date on which an owner terminated ownership as an end-of-ownership date for each of vehicles in a first vehicle group among the plurality of vehicles, and acquire, for each of vehicles in a second vehicle group for which corresponding consent status data indicates that an owner consented to the disclosure other than the vehicles in the first vehicle group among the plurality of vehicles, corresponding vehicle identification data as inquiry vehicle data; and
a communication interface configured to:
transmit request data including the inquiry vehicle data acquired by the controller to a management system that manages a second database in which data indicating a date on which one or more types of registration procedures were performed and a type of registration procedure performed is stored for each vehicle of the plurality of vehicles; and
receive response data that is transmitted in response to the request data transmitted and includes vehicle identification data for a vehicle among the vehicles in the second vehicle group for which a certain type of registration procedure has been performed within a reference period,
wherein the controller is configured to calculate, for the vehicle identified by the vehicle identification data included in the response data received by the communication interface, a corresponding end-of-ownership date based on the reference period.

2. The information processing apparatus according to claim 1, wherein
the controller is configured to refer to the first database and acquire the inquiry vehicle data for each unit period,
the communication interface is configured to transmit the request data for each unit period,
the reference period is a unit period one unit before a unit period in which the request data is transmitted, and
the controller is configured to calculate, for the vehicle identified by the vehicle identification data included in the response data, the last day of the reference period as the corresponding end-of-ownership date.

3. The information processing apparatus according to claim 1, wherein the controller is configured to refer to, after reception of the response data by the communication interface, the first database again to determine, for the vehicle identified by the vehicle identification data included in the response data, whether corresponding ownership period data is stored in the first database, and add data indicating the end-of-ownership date calculated to the first database as the corresponding ownership period data upon determining that the corresponding ownership period data is not stored in the first database.

4. The information processing apparatus according to claim 1, wherein
the first database stores, for each of vehicles in vehicle groups other than the first vehicle group among the plurality of vehicles, dummy period data indicating a fixed date instead of an end-of-ownership date in a same format as the ownership period data, and
the controller is configured to refer to the first database and identify, as the vehicles in the second vehicle group from among the plurality of vehicles, a group of vehicles for which the corresponding consent status data indicates that owners consented to the disclosure and for which corresponding dummy period data indicates the fixed date.

5. The information processing apparatus according to claim 1, wherein the response data includes vehicle identification data for a vehicle for which a registration procedure for owner's name change and owner's address change has been performed within the reference period.

6. The information processing apparatus according to claim 1, wherein the response data includes vehicle identification data for a vehicle for which a deletion registration procedure has been performed within the reference period, where the deletion registration procedure is a registration procedure for temporary discontinuation of use, export, or dismantling.

7. The information processing apparatus according to claim 1, wherein
the controller is configured to further include inquiry condition data specifying a type of registration procedure in the request data, and
the response data includes vehicle identification data for a vehicle for which a registration procedure of the type specified by the inquiry condition data has been performed within the reference period.

8. The information processing apparatus according to claim 1, wherein the management system is a system operated by a government agency that administers registration procedures or an agency that administers the registration procedures on behalf of the government agency.

9. The information processing apparatus according to claim 1, wherein the controller is configured to refer to a third database in which, for each vehicle of the plurality of vehicles, corresponding vehicle identification data and contract status data indicating whether an owner is under contract for a service associated with a vehicle are stored, and include, for each of vehicles in a third vehicle group among the plurality of vehicles for which corresponding contract status data indicates that an owner is under contract for the service, the corresponding vehicle identification data in the request data as additional inquiry vehicle data while avoiding duplication.

10. The information processing apparatus according to claim 9, wherein the controller is configured to update contract status data stored in the third database for the vehicle identified by the vehicle identification data included in the response data to data indicating that an owner is not under contract for the service.

11. An information processing method comprising:
referring to a first database in which vehicle identification data, consent status data, and ownership period data are stored, the vehicle identification data identifying each vehicle of a plurality of vehicles, the consent status data indicating whether, for each vehicle of the plurality of vehicles, an owner consented to disclosure of information obtained from a vehicle, and the ownership period data indicating a date on which an owner terminated ownership as an end-of-ownership date for each of vehicles in a first vehicle group among the plurality of vehicles, and acquiring, for each of vehicles in a second vehicle group for which corresponding consent status data indicates that an owner consented to the disclosure other than the vehicles in the first vehicle group among the plurality of vehicles, corresponding vehicle identification data as inquiry vehicle data;
transmitting request data including the inquiry vehicle data acquired to a management system that manages a second database in which data indicating a date on which one or more types of registration procedures were performed and a type of registration procedure performed is stored for each vehicle of the plurality of vehicles;
receiving response data that is transmitted in response to the request data transmitted and includes vehicle identification data for a vehicle among the vehicles in the second vehicle group for which a certain type of registration procedure has been performed within a reference period; and
calculating, for the vehicle identified by the vehicle identification data included in the response data received, a corresponding end-of-ownership date based on the reference period.

12. The information processing method according to claim 11, wherein
the acquiring of the inquiry vehicle data and the transmitting of the request data are performed for each unit period,
the reference period is a unit period one unit before a unit period in which the request data is transmitted, and
the calculating includes calculating, for the vehicle identified by the vehicle identification data included in the response data, the last day of the reference period as the corresponding end-of-ownership date.

13. The information processing method according to claim 11, further comprising referring to, after the receiving of the response data, the first database again to determine, for the vehicle identified by the vehicle identification data included in the response data, whether corresponding ownership period data is stored in the first database, and adding data indicating the end-of-ownership date calculated to the first database as the corresponding ownership period data upon determining that the corresponding ownership period data is not stored in the first database.

14. The information processing method according to claim 11, wherein
the first database stores, for each of vehicles in vehicle groups other than the first vehicle group among the plurality of vehicles, dummy period data indicating a fixed date instead of an end-of-ownership date in a same format as the ownership period data, and
the information processing method further comprises referring to the first database and identifying, as the vehicles in the second vehicle group from among the plurality of vehicles, a group of vehicles for which the corresponding consent status data indicates that owners consented to the disclosure and for which corresponding dummy period data indicates the fixed date.

15. The information processing method according to claim 11, wherein the response data includes vehicle identification data for a vehicle for which a registration procedure for owner's name change and owner's address change has been performed within the reference period.

16. The information processing method according to claim 11, wherein the response data includes vehicle identification data for a vehicle for which a deletion registration procedure has been performed within the reference period, where the deletion registration procedure is a registration procedure for temporary discontinuation of use, export, or dismantling.

17. The information processing method according to claim 11, wherein
the request data further includes inquiry condition data specifying a type of registration procedure, and
the response data includes vehicle identification data for a vehicle for which a registration procedure of the type specified by the inquiry condition data has been performed within the reference period.

18. The information processing method according to claim 11, wherein the management system is a system operated by a government agency that administers registration procedures or an agency that administers the registration procedures on behalf of the government agency.

19. The information processing method according to claim 11, further comprising referring to a third database in which, for each vehicle of the plurality of vehicles, corresponding vehicle identification data and contract status data indicating whether an owner is under contract for a service associated with a vehicle are stored, and including, for each of vehicles in a third vehicle group among the plurality of vehicles for which corresponding contract status data indicates that an owner is under contract for the service, the corresponding vehicle identification data in the request data as additional inquiry vehicle data while avoiding duplication.

20. The information processing method according to claim 19, further comprising updating contract status data stored in the third database for the vehicle identified by the vehicle identification data included in the response data to data indicating that an owner is not under contract for the service.
